(19) United States
(12) Patent Application Publication
(10) Pub. No.: US 2008/0230301 A1
(43) Pub. Date: Sep. 25, 2008

(54) Steering System for Motor Vehicles

(75) Inventor: Roland Roell, Aidlingen (DE)

Correspondence Address: CROWELL & MORING LLP;INTELLECTUAL PROPERTY GROUP, P.O. BOX 14300, WASHINGTON, DC, 20044-4300, US

(73) Assignee: DaimerChrysler AG, Stuttgart (DE)

(21) Appl. No.: 11/587,588

(22) PCT Filed: Apr. 20, 2005
(86) PCT No.: PCT/EP05/04221

§ 371 Date: Oct. 23, 2007

(30) Foreign Application Priority Data
Apr. 27, 2004 (DE) 10 2004 020 434.9

(51) Int. Cl. B62D 5/06

(52) U.S. Cl. 180/417; 180/403

(57) ABSTRACT

A steering system for a motor vehicle is disclosed, including a steering member which is connected to a pinion, the pinion being in engagement with a steering rack, which is connected to a master piston, slave pistons connected to the vehicle wheels, and volumes, which are arranged between slave pistons and master piston and are filled with hydraulic fluid for transmitting steering forces. According to the invention, there is provision in the steering system for a first volume to be connected to a second volume via a hydraulic line, hydraulic fluid being transferable between the volumes for influencing a steering ratio. This system is for use in motor vehicles, in particular passenger cars.

### BACKGROUND OF THE INVENTION

The invention relates to a steering system for motor vehicles.

Reference DE 196 03 568 A1 discloses a steering system in which a steering wheel and the vehicle wheels are coupled hydraulically. The steering system includes a master unit and a slave unit. The master and slave units are in the form of double-acting piston/cylinder units. A pinion connected to the steering wheel transmits the steering movements of a driver to a steering rack, which executes a sliding movement. The steering rack is connected to the piston of the master unit, hereinafter called master piston. A piston of the slave unit, hereinafter called slave piston, is connected to the vehicle wheels. A volume filled with hydraulic fluid is arranged between the master piston and the slave piston on each side thereof. The volumes are distributed proportionally to the master and slave units and the hydraulic lines.

The volumes have a constant value; the cross-sectional areas of the master and slave pistons are equal. When the master piston is displaced, the volumes arranged on each side of the piston are displaced, so that the slave piston is displaced by the same amount and steering of the vehicle wheels is achievable.

### SUMMARY OF THE INVENTION

It is an object of the invention, in contrast to the foregoing, to make available a steering system which makes variation of the steering ratio possible.

This object is achieved by a steering system having the features of a steering system for motor vehicles, including a steering member which is effectively connected to a pinion, the pinion being in engagement with a steering rack, which is connected to a master piston, slave pistons which are connected to the vehicle wheels, and volumes which are arranged between slave pistons and master piston and are filled with hydraulic fluid for transmitting steering forces, characterized in that a first volume is connected to a second volume via a hydraulic line, hydraulic fluid being transferable between the volumes for influencing a steering ratio.

The steering system according to the invention is distinguished by a hydraulic line connecting a first volume and a second volume, hydraulic fluid being transferable between the volumes for influencing a steering ratio. A first volume and a second volume are arranged between the master and slave pistons. The volumes are filled with hydraulic fluid. The first and second volumes are variable via a flow of hydraulic fluid in the hydraulic line. If the first volume is reduced or increased by a value, the second volume is increased or reduced by this value. The displacement travel of the slave piston can advantageously be uncoupled from the displacement travel of the master piston. By specifying a flow of hydraulic fluid flowing via the hydraulic line the transmission ratio between the master and slave pistons, and therefore the steering ratio, can be determined with the system described.

In an embodiment of the invention, a variable throttle element is incorporated in the hydraulic line. The throttle element changes the flow resistance by changing the cross-sectional area of a flow aperture or by pulsed opening and closing of said flow aperture. Advantageously, the hydraulic line can be completely blocked via the throttle element; the steering system then has a steering ratio predefined by a rack and pinion. Opening of the throttle element during a steering process causes hydraulic fluid to flow through the hydraulic line, whereby the steering ratio is increased.

In a further embodiment of the invention, the throttle element is electrically activatable. The electrical activatability of the throttle element makes activation via a control unit possible, so that the flow resistance of the throttle element is variable in dependence, for example, on vehicle-related data available on an on-board computer network (CAN).

In a further embodiment of the invention, the volumes are connected to one another via a pump. Hydraulic fluid is conveyable from the first volume to the second volume and vice-versa via the preferably electrically activatable pump. The pump makes displacement possible of the slave pistons connected to the vehicle wheels, whereby steering movement independent of movement of the steering rack can be executed. The direction of rotation and the flow rate of the pump are advantageously variable.

In a further embodiment of the invention, the steering rack has a master piston at each end. The pistons are connected to the steering rack via a positive method such as a screw connection, a non-positive method such as a press fit, and/or via a joining method such as welding or soldering. In a further alternative, the master pistons and the steering rack are formed in one piece. The pistons are sealed with respect to a running surface via sealing rings.

In a further embodiment of the invention, the steering rack is arranged with the master pistons in a tube element connected to the vehicle wheels. The steering rack with the master pistons is arranged displaceably in the tube element, so that the tube element is movable relative to the steering rack. The tube element can be produced at low cost. In addition, the tube element has high stiffness, so that no deformation occurs under the influence of steering forces.

In a further embodiment of the invention, the end faces of the tube element are configured as slave pistons. The bases that close the tube element are referred to herein as end faces. The end faces may be formed in one piece with the tube element; in the alternative, one or both end faces may be in the form of a supplementary part. An end face in the form of a supplementary part is connectable to the tube element, for example, by means of a screw thread. The first and second volumes are delimited by the master pistons and the end faces. In a cost-effective configuration, the end faces are utilized as slave pistons.

In a further embodiment of the invention, the tube element is articulated to the vehicle wheels via track rods. The tube element represents a solid connection between the vehicle wheels, so that the steering angles of both wheels always have a fixed correspondence to one another.

In a further embodiment of the invention, springs are arranged between the master and slave pistons. The springs are arranged in the first and second volumes. The steering rack is therefore braced between the springs. In the load-free state the steering rack adopts a defined position. The springs are preferably in the form of helical springs. To compensate for temperature-dependent variation of the viscosity of the hydraulic fluid, springs having a temperature-dependent characteristic curve may be utilized. In addition to individual springs, springs disposed in parallel and/or in series may be arranged in the volumes.

In a further embodiment of the invention, the steering system has hydraulic assistance. The same hydraulic fluid as in the first and second volumes may be used in the hydraulic steering assistance. A common oil supply for the steering assistance and for the steering system according to the invention can therefore advantageously be used.

### BRIEF DESCRIPTION OF THE DRAWINGS

Further features and combinations of features will be apparent from the description and the drawings. Concrete embodiments of the invention are represented in simplified form in the drawings and are explained in more detail in the following description. In the drawings:

FIG. 1 is a schematic representation of a steering system according to an embodiment of the invention;

FIG. 2 shows a device from FIG. 1 to implement a variable steering ratio.

### DETAILED DESCRIPTION OF THE INVENTION

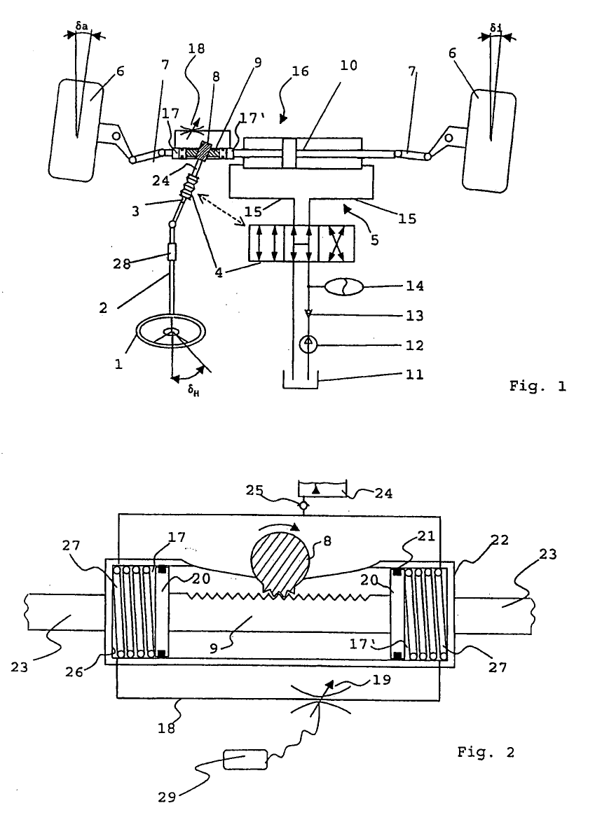

The same components in FIGS. 1-2 are denoted hereinafter by the same designations.

FIG. 1 shows a steering system according to the invention of a motor vehicle (not illustrated in detail), which includes a hydraulic steering assistance device 5 and a device for providing a variable steering ratio. A steering column 2 transmits the steering moment exerted by a driver on a steering member 1 in the form of a steering wheel, to an input shaft 3 of a steering gear 16. The current steering angle and the steering angular velocity are detected via a steering angle sensor 28.

The steering gear 16 includes a housing with which are associated a pinion 8 and a steering rack 9. The pinion 8 is, on the one hand, effectively connected to the input shaft 3 and, on the other, is in engagement with the steering rack 9. This arrangement converts the rotary movement of the input shaft 3 and of the pinion 8 into a sliding movement of the steering rack 9.

The steering rack 9 is connected via a first and a second volume 17, 17′, which are filled with hydraulic fluid, to a left-hand and a right-hand track rod 7. The volumes 17, 17′ transmit a sliding movement of the steering rack 9 to the vehicle wheels 6. Depending on the direction of movement of the steering rack 9, the vehicle wheels 6 are steered left or right. The volumes 17, 17′ filled with hydraulic fluid are connected to one another via a hydraulic line 18, in which an electrically activatable throttle element 19 is incorporated.

In addition, a steering assistance device 5, including a double-acting piston/cylinder unit 10 coupled to the steering rack 9, is arranged in the steering gear 16. Depending on the direction of rotation of the steering wheel 1, either the right-hand or the left-hand side of the steering assistance piston is subjected to pressure. A steering valve 4 controls the required oil pressure depending on the steering moment. In addition to the schematic representation of the steering valve 4, for better understanding of its operation a symbolic block circuit diagram of the steering valve 4 is indicated by an arrow in FIG. 1.

A mechanically or electrically driven steering assistance pump 12 generates a required oil pressure for the steering assistance. The steering assistance pump 12 delivers oil from a reservoir 11 via a feed line and a valve 13 to the steering valve 4, and from there via pressure lines 15 to the steering gear 16. Discharged oil flows back to the reservoir 11 via a return line. In a modified embodiment, a pressure accumulator 14 is arranged in the oil circuit. If the steering assistance pump 12 malfunctions, steering assistance is therefore still maintained for a certain time.

FIG. 2 shows in detail the arrangement of the steering gear 16, which makes possible a variable steering ratio. Two master pistons 20 are arranged on the steering rack 9. The steering rack 9 is guided via the master pistons 20 in a tube element 22. The steering rack 9 is axially displaceable via rotation of the pinion 8, which is effectively connected to the steering wheel 1 of FIG. 1. The pinion 8 has teeth over its full circumference; for simplicity, only teeth in engagement with the steering rack 9 are illustrated. Volumes 17, 17′ filled with hydraulic fluid are provided between the master pistons 20 and the end faces 26 of the tube element 22, which are configured as slave pistons. Associated with the tube element 22 are rod elements 23, which establish a connection to the track rods 7 shown in FIG. 1. The volumes 17, 17′ delimited by the tube element 22 and the master pistons 20 are connected to one another via a hydraulic line 18. An electrically activatable throttle element 19 is incorporated in the hydraulic line 18. The throttle element 19 is connected to a control unit 29, which activates the throttle element 19 in dependence on parameters such as vehicle speed, steering moment, yaw angular velocity, steering angle, and/or steering angular velocity. In addition, the hydraulic volumes 17, 17′ are connected to a tank 24. A non-return valve 25 arranged before the tank 24 prevents hydraulic fluid from flowing back into the tank 24. The tank 24 is preferably combined with the reservoir 11 in FIG. 1 as a functional unit. The hydraulic volumes 17, 17′ are permanently filled with hydraulic fluid via the connection with the tank 24.

If the valve 19 is closed, the steering has a very sporting character because of a direct selected steering ratio. This ratio is advantageous with rapid steering movements, during parking or at low driving speeds. If the pinion 8 rotates, for example, in the direction of the arrow shown in FIG. 2, a pressure of the following value builds up in the volume 17 filled with hydraulic fluid to the left of the pinion 8:

$${P}_{17} = \frac{2 * {M}_{L}}{{dk}_{pinion} * {A}_{k}} ,$$

Where P₁₇: pressure in hydraulic fluid volume 17

M_{L}: steering moment

dKₚᵢₙᵢₒₙ: reference diameter of pinion 8

A_{K}: area of master piston 20.

This pressure P₁₇ acts on the inner face 26 of the tube element 22 corresponding in size to the area A_{K}. The force on the steering rack 9 resulting from the steering moment M_{L} therefore acts on the tube element 22, which is connected to the vehicle wheels 6 via the track rods 7. With the throttle element 19 closed, a steering ratio i₁ is established, which corresponds to a conventional system with a fixed mechanical connection between steering rack 9 and track rod 7. The steering gear ratio is determined by i₁=δ_{H}/δₘ, where δm=(δa+δi)/2 describes the mean road wheel turning angle and δ_{H} the steering wheel angle of rotation; see FIG. 1.

At higher driving speeds direct steering is uncomfortable; first, even small movements of the steering wheel 1 cause high yaw acceleration and, second, oscillations generated by the road surface are disturbingly perceptible. It is therefore desired to make available less direct steering at elevated speeds than, for example, while parking. By opening the electric throttle element 19 an exchange of hydraulic fluid between the volumes 17, 17′ arranged to the left and right of the steering rack 9 can be achieved. The flow resistance of the throttle element 19 is adjustable via the electrical activation of the throttle element 19.

If the pinion 8 rotates in, for example, the direction of the arrow shown in FIG. 2 with the throttle element 19 open, the steering rack 9 moves relative to the tube element 22. The relative velocity vᵣₑₗ is determined by the volume flow Q of hydraulic fluid through the hydraulic line 18 governed by the throttle element 19, which relative velocity is defined by the following equation:

Vᵣₑₗ=Q/Aₖ.

The displacement velocity of the tube element 22 depends on the pressure P₁₇ built up in the left-hand volume 17, which acts on the face 26 of the tube element 22. This pressure depends on the steering velocity, i.e., on the displacement velocity of the steering rack 9 and on the flow resistance set at the throttle element 19. With a predefined flow resistance a low vᵣₑₗ is established, for example, at a first high steering velocity, i.e., the relative movement of the steering rack 9 with respect to the tube element 22 is very small. By contrast, at lower steering velocities, as compared to the first, a higher vᵣₑₗ is generated.

To produce a wheel turning angle δ m with the throttle element 19 open, the steering wheel angle of rotation δ_{H} is larger, because of the additional relative movement, than in an arrangement with a fixed steering gear ratio i₁, i.e., the steering has a higher ratio i2>i1.

To center the steering rack 9 in a middle position or to restore same to the middle position, two springs 27 are arranged in the volumes 17. The springs 27 are braced between the master pistons 20 and the inner faces 26 of the tube element 22. The restoration to the middle position can be influenced by activating the throttle element 19 during the return movement of the steering.

A steering operation with a steering ratio i2 takes place, for example, as follows. The steering angle sensor 28 detects steering into a curve; the steering angle sensor 28 supplies this information, for example, via an onboard computer network, to the control unit 29, which sets a flow resistance at the throttle element 19 in dependence on steering angular velocity and vehicle speed. When driving round a curve, the driver turns the steering wheel 1 until the desired steering angle δm is established at the vehicle wheels 6. As this happens, a relative movement occurs between steering rack 9 and tube element 22. When the turning-in action is ended the driver holds the steering wheel 1 in a largely fixed position in which the throttle element 19 closes again. When driving round the curve is completed, the driver turns the steering wheel 1, assisted by a steering restoration moment, back to the straight-ahead position. In this restoration phase the throttle element 19 opens, so that the springs 27 again center the steering rack 9 with respect to the tube element 22.

The steering system according to the invention may advantageously be utilized to damp, for example, road shocks, shimmy, or flutter. While driving straight ahead, shocks induced by the road surface can be damped by a partial opening of the throttle element 19; the use of an additional steering damper is superfluous.

With the above-described steering system, widely differing steering characteristics can advantageously be reproduced via activation of the electric throttle element 19.

The implementation of direct steering can also be achieved, in addition to complete closing of the electric throttle element 19, by means of an additional valve interrupting the hydraulic line.

In a modified embodiment (not illustrated) an electrically activatable pump is incorporated in the hydraulic line 18. Active steering intervention can be implemented via the pump. This provides a possibility of setting a high basic ratio i₁, i.e., a ratio with an indirect characteristic curve. By pumping hydraulic fluid from the first volume 17 to the second volume 17′ or vice versa, a relative displacement of the steering rack 9 with respect to the tube element 22 is produced. A steering angle δm can therefore be increased by a value Δδm, without the steering wheel angle δ_{H} being changed.

The possibility of delivering an additional steering angle Δδm can be used to implement more direct steering with i₂<i₁. In addition, active steering interventions can be used for vehicle stabilization, in particular in conjunction with other systems operating via braking intervention.

In a further modified embodiment, both a throttle element 19 and a pump are provided in the steering system. An electrically activatable valve connects the throttle element 19 and the pump jointly or selectively into the hydraulic line 18. The pump may be arranged in parallel or in series with the throttle element 19.

1-10. (canceled)

11. A steering system for motor vehicles comprising:
a steering member which is effectively connected to a pinion, the pinion being in engagement with a steering rack which is connected to a master piston;
slave pistons which are connected to vehicle wheels; and
volumes which are arranged between slave pistons and master piston and are filled with hydraulic fluid for transmitting steering forces,
wherein a first volume is connected to a second volume via a hydraulic line, hydraulic fluid being transferable between the volumes for influencing a steering ratio.

12. A steering system for motor vehicles comprising:
a steering member connected to a pinion, said pinion being in engagement with a steering rack;
a first slave piston connected to a first vehicle wheel;
a second slave piston connected to a second vehicle wheel;
first and second master pistons, said first and second master pistons being connected to said steering rack;
a first volume arranged between said first slave and first master pistons;
a second volume arranged between said second slave and second master pistons,
wherein said first and second volumes being connected via a hydraulic line for transferring hydraulic fluid for influencing a steering ratio.

13. The steering system of claim 12, wherein a variable throttle element is incorporated in the hydraulic line.

14. The steering system of claim 12, wherein the throttle element is electrically activatable.

15. The steering system of claim 12, wherein the first and second volumes are connected to one another via a pump.

16. The steering system of claim 12, wherein the steering rack has a master piston at each end.

17. The steering system of claim 12, wherein the steering rack is arranged with the master pistons in a tube element connected to the vehicle wheels.

18. The steering system of claim 17, wherein end faces of the tube element are configured as slave pistons.

19. The steering system of claim 17, wherein the tube element is articulated to the vehicle wheels via track rods.

20. The steering system of claim 12, wherein springs are arranged between the master and slave pistons.

21. The steering system of claim 12, wherein the steering system includes a steering assistance device.
